(19) United States
(12) Patent Application Publication
(10) Pub. No.: US 2021/0388149 A1
(43) Pub. Date: Dec. 16, 2021

(54) A Polyester Polyol and Polyurethane Polymers Made Therefrom

(71) Applicant: 3M INNOVATIVE PROPERTIES COMPANY, St. Paul, MN (US)

(72) Inventors: Yongshang Lu, Woodbury, MN (US); David T. Amos, St. Paul, MN (US); Zhong Chen, Woodbury, MN (US); Encai Hao, Woodbury, MN (US); Charlie C. Ho, Woodbury, MN (US); Yu Yang, Eden Prairie, MN (US)

(21) Appl. No.: 17/283,114

(22) PCT Filed: Nov. 20, 2019
(86) PCT No.: PCT/IB2019/059976

§ 371 Date: Apr. 6, 2021

Related U.S. Application Data
(60) Provisional application No. 62/770,387, filed on Nov. 21, 2018.

(51) Int. Cl. C08G 18/42; C08G 63/54; C08G 63/85; C08G 18/34; C08G 18/66; C08G 18/24; C08G 18/73; C09J 7/38; C09J 5/00

(52) U.S. Cl. CPC C08G 18/4288; C08G 63/54; C08G 63/85; C08G 18/341; C08G 18/6659; C09J 2301/302; C08G 18/73; C09J 7/38; C09J 5/00; C09J 2475/00; C08G 18/246

(57) ABSTRACT

Described herein is a polyester polyol, which is derived from a first reaction product of (a) a Component A, wherein the Component A is a phthalic acid, a phthalic anhydride or mixtures thereof, (b) a Component B, wherein the Component B is a dimer fatty acid, a dimer fatty acid diol or mixtures thereof, and (c) a Component C, wherein the Component C is an aliphatic diol, an aromatic diol, or mixtures thereof, wherein Component C comprises 2 to 10 carbon atoms and optionally catenated heteroatoms selected from O, S, and N. Also disclosed herein are polyurethane polymers and pressure sensitive adhesives made from the polyurethane polymers or the polyester polyols.

### TECHNICAL FIELD

A polyester polyol is disclosed. In one embodiment, the lower molecular weight polyester polyol is reacted with a polyisocyanate to form a polyurethane polymer and such polymers can be used to form an adhesive. In another embodiment, a higher molecule weight polyester polyol is used to form an adhesive. Such adhesives can have good conformability and/or dimensional stability which can be advantageous in die-cut adhesive articles.

### SUMMARY

A polyester polyol is disclosed along with polyurethane polymers and adhesives thereof. In one embodiment, there is a desire to identify an adhesive which, in addition to being chemically resistant, also has dimensional control and/or conformability.

In one embodiment, polyester polyol is disclosed, the polyester polyol comprising: a first reaction product of:
(a) a Component A, wherein the Component A is a phthalic acid, a phthalic anhydride or mixtures thereof,
(b) a Component B, wherein the Component B is a dimer fatty acid, a dimer fatty acid diol or mixtures thereof, and
(c) a Component C, wherein the Component C is an aliphatic or aromatic diol comprising 2 to 10 carbon atoms and optional catenated heteroatoms selected from O, S, and N.

In another embodiment, a polyurethane polymer, which is a reaction product of the polyester polyol and a polyisocyanate component is disclosed.

In yet another embodiment, a pressure sensitive adhesive composition, which is derived from the polyester polyol and/or the polyurethane polymer is disclosed.

Also described are articles such as laminating tapes as well as methods of bonding substrates with the pressure sensitive adhesive composition and laminating tape.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“crosslinking” refers to connecting two pre-formed polymer chains using chemical bonds or chemical groups;

“monomer” is a molecule which can undergo polymerization which then form part of the essential structure of a polymer; and

“(meth)acrylate” refers to compounds containing either an acrylate (CH₂═CHCOOR) or a methacrylate (CH₂═CCH₃COOR) structure or combinations thereof.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

Polyester Polyol

The polyester polyol composition disclosed herein is a condensation product of at least three components, Component A, Component B, and Component C.

Component A is a phthalic acid, a phthalic anhydride, or mixtures thereof. Phthalic acid as used herein refers to an aromatic dicarboxylic acid of the formula C₆H₄(CO₂H)₂ and includes the ortho-, meta-, and para-isomers (i.e., phthalic acid, isophthalic acid, and terephthalic acid). Phthalic acid is commercially available from suppliers such as MilliporeSigma, St. Louis, Mo. Phthalic anhydride is the anhydride of phthalic acid. Phthalic anhydride is commercially available from many suppliers, including MilliporeSigma and Stepan Company (Northfield, Ill.), and any desired form (e.g., flake, molten) can be used. The purity of phthalic acid and phthalic anhydride is not considered critical for the disclosed method. Preferably, however, the phthalic acid and/or phthalic anhydride is at least 95% pure, or even at least 98% pure.

In one embodiment, the polyester polyol is derived from at least 20, 25, or even 30 weight percent of Component A and at most 40, 50, or even 60 weight percent of Component A.

Component B is a dimer fatty acid, a dimer fatty acid diol, or mixtures thereof. Dimer fatty acids (also known as dimer fatty acids or dimer acids) are mixtures prepared by oligomerization of unsaturated fatty acids. The phrase “fatty acid,” as used herein means an organic compound composed of an alkyl or alkenyl group containing 5 to 22 carbon atoms and characterized by a terminal carboxylic acid group. Useful fatty acids are disclosed in “Fatty Acids in Industry: Processes, Properties, Derivatives, Applications”, Chapter 7, pp 153-175, Marcel Dekker, Inc., 1989. In some embodiments, the dimer fatty acid may be formed by the dimerization of unsaturated fatty acids having 18 carbon atoms such as oleic acid or tall oil fatty acid. The dimer fatty acids are often at least partially unsaturated and often contain 36 carbon atoms. The dimer fatty acids may be relatively high molecular weight and made up of mixtures comprising various ratios of a variety of large or relatively high molecular weight substituted cyclohexenecarboxylic acids, predominately 36-carbon dicarboxylic dimer acid. Component structures may be acyclic, cyclic (monocyclic or bicyclic) or aromatic, as shown below.

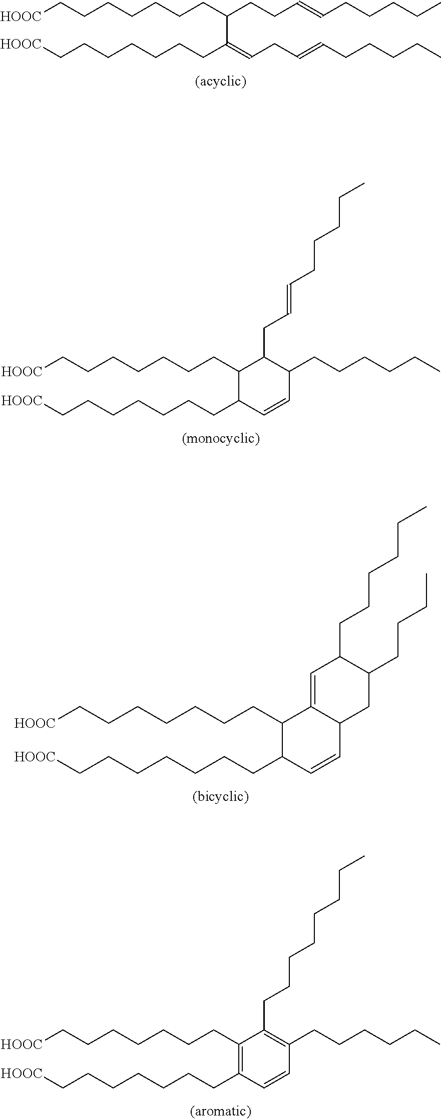 [SMILES: CCCCC/C=C/C/C=C(/CCCCCCCC(=O)O)C(CC/C=C/CCCCC)CCCCCCCC(=O)O ; CCCCC/C=C/CC1C(CCCCCC)C=CC(CCCCCCCC(=O)O)C1CCCCCCCC(=O)O ; CCCCCCC1C=C2C(C=CC(CCCCCCCC(=O)O)C2CCCCCCCC(=O)O)CC1CCCC ; CCCCCCCCc1c(CCCCCC)ccc(CCCCCCCC(=O)O)c1CCCCCCCC(=O)O]

The dimer acids may be prepared by condensing unsaturated monofunctional carboxylic acids such as oleic, linoleic, soya or tall oil acid through their olefinically unsaturated groups, in the presence of catalysts such as acidic clays. The distribution of the various structures in dimer acids (nominally C₃₆ dibasic acids) depends upon the unsaturated acid used in their manufacture. Typically, oleic acid gives a dicarboxylic dimer acid containing about 38% acyclics, about 56% mono- and bicyclics, and about 6% aromatics. Soya acid gives a dicarboxylic dimer acid containing about 24% acyclics, about 58% mono- and bicyclics and about 18% aromatics. Tall oil acid gives a dicarboxylic dimer acid containing about 13% acyclics, about 75% mono- and bicyclics and about 12% aromatics. The dimerization procedure also produces trimer acids. The commercial dimer acid products are typically purified by distillation to produce a range of dicarboxylic acid content. Useful dimer acids contain at least 80% dicarboxylic acid, more preferably 90% dicarboxylic acid content, even more preferably at least 95% dicarboxylic acid content. For certain applications it may be advantageous to further purify the dimer acid by color reduction techniques including hydrogenation of the unsaturation, as disclosed in U.S. Pat. No. 3,595,887, which is incorporate herein by reference in its entirety. Hydrogenated dimer acids may also provide increased oxidative stability at elevated temperatures. Other useful dimer acids are disclosed in Kirk-Othmer Encyclopedia of Chemical Technology. Organic Chemicals: Dimer Acids (ISBN 9780471238966), copyright 1999-2014, John Wiley and Sons, Inc. Useful dimer acids contain at least 80% dicarboxylic acid, more preferably 90% dicarboxylic acid content, even more preferably at least 95% dicarboxylic acid content.

Exemplary commercially available dicarboxylic dimer acids are available under the trade designation EMPOL1008 and EMPOL1061 both from BASF, Florham Park, N.J.; PRIPOL 1006, PRIPOL 1009, PRIPOL 1013, PRIPOL 1017, PRIPOL 1025 and PRIPOL 2033 all from Coroda Inc., Edison, N.J.: Radiacid 0970, Radiacid 0971, Radiacid 0972, Radiacid 0975, Radiacid 0976, and Radiacid 0977 from Oleon, Ertvelde, Belgium; and UNIDYME 10 and UNIDYME TI from Kraton Corp., Savannah, Ga.

In some embodiments, the number average molecular weight of the dicarboxylic dimer acid, e.g. the non-aromatic dicarboxylic dimer acid, may be between from 300 g/mol to 1400 g/mol, between from 300 g/mol to 1200 g/mol, between from 300 g/mol to 1000 g/mol or even between from 300 g/mol to 800 g/mol. In some embodiments, the average number of carbon atoms in the dicarboxylic dimer acid, e.g. the non-aromatic dicarboxylic dimer acid, is at least 20, 25, or even 30 and at most 40, 45, 50, 55, or even 60 carbon atoms.

In one embodiment, the polyester polyol is derived from at least 10, 15, 20, or even 25 weight percent of Component B and at most 30, 40, 50, or even 60 weight percent of Component B.

Component C is an aliphatic diol, an aromatic diol, or mixtures thereof, wherein Component C comprises 2 to 10 carbon atoms. Component C, the aliphatic diol or aromatic diol, may optionally comprise at least one catenated heteroatom such as O (i.e., ether linkage), S (i.e., a thioether linkage), and N (i.e., a secondary amine). The aliphatic diol may be linear or branched, saturated or unsaturated having 2, 3, 4, 5, 6, 7, 8, 9, or 10 carbon atoms, at least two hydroxy (—OH) groups, and optionally, at least one catenated heteroatom. The aromatic diol comprises 2, 3, 4, 5, 6, 7, 8, 9, or 10 carbon atoms and two hydroxy (—OH) groups, which are in the ortho-, meta- or para-orientation on the ring and optionally, at least one catenated heteroatom. The aromatic diol may comprise more than two hydroxy groups. Suitable aliphatic and aromatic diols are compounds having at least two hydrogen atoms being reactive with Components A and B. Exemplary aliphatic diols include: 1,3-butanediol, 1,4-butanediol, 1,5-pentanediol, 1,6-hexanediol, 1,7-heptanediol, 1,8-octanediol, 2,2-dimethyl-1,3-propanediol (neopentyl glycol), 3-methyl-1,5-pentanediol, 2,2,4-trimethyl-1,6-hexanediol, ethylene glycol, 2-methyl-1,3-propanediol, and polyethylene glycols having a number average molecular weight within the range of 200 g/mol to 600 g/mol, and mixtures thereof.

In one embodiment, the polyester polyol is derived from at least 20, 25 30, or even 35 weight percent of Component C and at most 40, 50, or even 60 weight percent of Component C.

Shown below is an exemplary reaction scheme of phthalic anhydride (A) with a fatty acid ester (B) and an aliphatic diol (C). The diol condenses with the carboxylic acid or ester groups to lose water and covalently bond the reactants together, wherein m is a repeating unit.

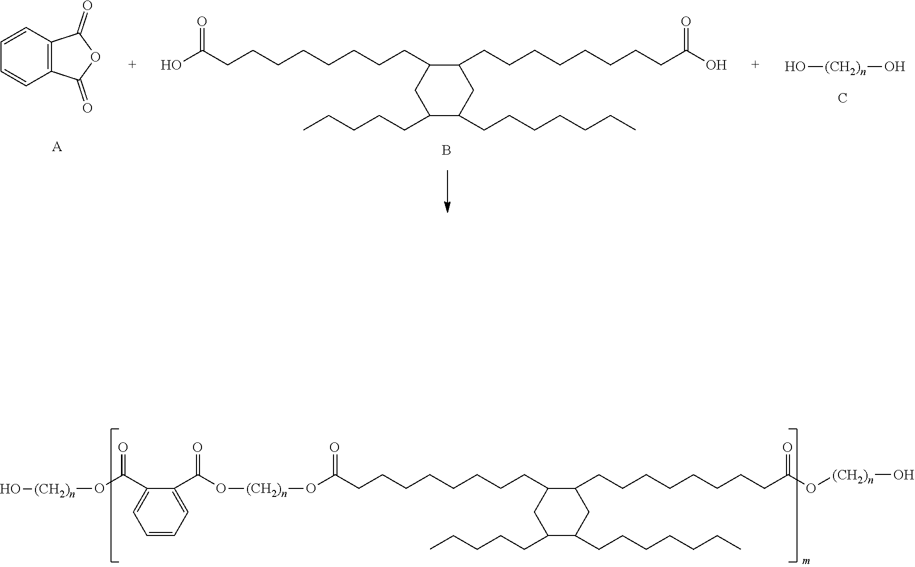

Although the reaction scheme above shows the aliphatic diol linking the fatty acid ester to the ring opened-phthalic anhydride, in practice and as known in the art, the fatty acid ester units and the ring opened-phthalic anhydride units are randomly bonded together in the polyester polyol molecule with the aliphatic diol linkages therebetween. If the fatty acid is a diol (instead of an ester), the diol group from the fatty acid may condense with the phthalic anhydride, forming a phthalic anhydride fatty acid diol linkage.

In one embodiment, the polyester diol is derived from essentially Components A, B and C, meaning either no additional reactive components are added, or very low amounts of additional reactive components are added, which do not impact the performance of the resulting polyester polyol.

In one embodiment, the polyester diol is derived from additional reactive components in addition to Components A, B and C.

In addition to the aliphatic diol and/or aromatic diol comprising 2 to 10 carbon atoms, in one embodiment, the polyester polyol is derived from a second aliphatic and/or aromatic diol, wherein this second aliphatic or aromatic diol comprises at least 11 carbon atoms and at least two hydroxy groups and optionally comprising at least one catenated heteroatom selected from O, S, and N. Exemplary second aliphatic and/or aromatic diols include 3-methyl-4-propyl-octane-2,6-diol, hydroquinone bis(2-hydroxy ethyl)ether, resorcinol bis(2-hydroxyethyl)ether, and bisphenol A bis(2-hydroxyethyl)ether. In one embodiment, the polyester polyol is derived from at least 1, 5, or even 10 weight percent of this second aliphatic and/or aromatic diol and at most 15, 20, or even 25 weight percent of this second aliphatic and/or aromatic diol.

In addition to Component A, which can comprise a compound having two acid groups, a second diacid can be used to generate the polyester polyol. Exemplary second diacids include oxalic acid, malonic acid, succinic acid, glutaric acid, adipic acid, pimelic acid, suberic acid, azelaic acid, sebacic acid, undecanedioic acid, dodecanedioic acid, brassylic acid, and thapsic acid. In one embodiment, the polyester polyol is derived from at least 1, 5, or even 8 weight percent of this second diacid and at most 10 or even 15 weight percent of this second diacid.

In one embodiment, the polyester polyols disclosed herein can be made by the reaction of Components A, B and C being simultaneously reacted together, wherein the components are polymerized onto the diol (e.g., Component B or C) by ring-opening polymerization of Component A and/or reaction with the acid portion of Component B. In another embodiment, it is also possible first to prepare alpha-hydroxy-gamma-carboxy-terminated polyesters, as for example by ring-opening polymerization of Component A or by polycondensation of the hydroxycarboxylic acids of Component B. The alpha-hydroxy-gamma-carboxy-terminated polyesters can then be reacted in turn with Component C, by means of a condensation reaction, to give the polyester diols for use in accordance with the disclosure.

Typically, the reaction of Components A, B and C and optional additional components occurs at temperatures of 160° C. or higher and in inert environments.

In one embodiment, a solvent may be employed. Exemplary solvents include xylene, and naphthalene. There are no peculiarities to the preparation of the polyester diol reaction product of the present disclosure. The esterification takes place commonly with the aid of a water separator. The reaction is discontinued when the polyester diol reaction product of the present disclosure possesses an acid number of less than 1 mg KOH/g or even less than 0.5 mg KOH/g. The acid number here is determined by means of ASTM E222-17.

In one embodiment, the resulting polyester polyol reaction product possesses a glass transition temperature (Tg) of below 15, 10, 5, 0, −5, −10, −15, −20, −25 or even −30° C. as determined by differential scanning calorimetry (DSC).

The resulting polyester polyol may be amorphous or have some crystallinity. The dimer acid can disrupt the structural regularity of the polyester polyol, thereby reducing or eliminating crystallinity in the resulting polyester polyol.

In one embodiment, the resulting polyester polyol reaction product possesses a number average molecular weight (Mn) of at least 1000, 1500, 2000, or even 2500 g/mol and at most 4000, 5000, 6000, 8000, or even 10,000 g/mol. These polyester polyols can be further reacted with polyisocyanates to generate polyurethanes, which can be used as a pressure sensitive adhesive, as will be discussed below.

In another embodiment, the resulting polyester polyol reaction product possesses a higher molecular weight, for example having a number average molecular weight (Mn) of at least 10000, 20000, or even 25000 g/mol and at most 50000, 75000, or even 100,000 g/mol. These polyester polyols can be used in a pressure sensitive adhesive as will be discussed below.

Polyurethane

The polyester polyol disclosed herein can be reacted with a polyisocyanate component to form a polyurethane polymer.

The polyisocyanate component may comprise various polyfunctional isocyanate compounds. Examples of such polyfunctional isocyanate compounds include polyfunctional aliphatic isocyanate compounds, polyfunctional aliphatic cyclic isocyanate compounds, and a polyfunctional aromatic isocyanate compounds.

Examples of the polyfunctional aliphatic isocyanate compounds include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate.

Examples of the polyfunctional aliphatic cyclic isocyanate compounds include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, hydrogenated tetramethylxylene diisocyanate, and bio-based polyfunctional aliphatic cyclic isocyanates, such as 2-heptyl-3,4-bis(9-isocyanatononyl)-1-pentylcyclohexane available under trade designation “DDI 1410” from BASF, Ludwigshafen, Germany.

Examples of the polyfunctional aromatic isocyanate compounds include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate.

In some embodiments, the polyfunctional isocyanate comprises a polyisocyanate that is a liquid at 25° C. alone or in combination with minor amount of a polyisocyanate that is a solid at 25° C. In other embodiments, such as when the polyol is an aliphatic polyol, the polyfunctional isocyanate is a solid at 25° C.

In some embodiments, the polyfunctional isocyanate compound comprises an aliphatic isocyanate compound, such as hexamethylene diisocyanate. In other embodiments, the polyfunctional isocyanate compound comprises a ortho- or meta-aromatic isocyanate compound, such as 1,4 methylene diphenyl diisocyanate (MDI), m-tetramethylene diisocyanate (TMXDI), or mixtures thereof.

In one embodiment, the polyurethane polymer is derived from at least 55, 60, 65, or even 70 wt % of the polyester polyol and at most 75, 80, 85, 90, 95, or even 99 wt % of the polyester polyol.

In one embodiment, the polyurethane polymer is derived from at least 1, 5, 8, or even 10 wt % of the polyisocyanate component and at most 15, 20, 25, 30, or even 35 wt % of the polyisocyanate component.

In one embodiment, the reaction product of the polyester polyol and the isocyanate component further comprise a functional acid containing compound. Such a functional acid containing compound is represented by the formula: (HX)₂R¹A and/or (HX)₂ R²(A)₂; wherein A is a functional acid group selected from —CO₂ M, —OSO₃ M, —SO₃ M, —OPO(OM)₂, —PO(OM)₂, wherein M is H or a cation having a valency of m, wherein m is 1, 2, or even 3; X is O, S, NH or NR wherein R is an alkylene group comprising 1 to 10 or even 1 to 4 carbon atoms; and R¹ is an organic linking group having a valency of 3 and R² is an organic linking group having a valency of 4, wherein R¹ and R² comprise 1 to 50, 1 to 30, 1 to 15, or even 1 to 7 carbon atoms, and optionally includes one or more tertiary nitrogen, ether oxygen, or ester oxygen atoms, and is free from isocyanate-reactive hydrogen containing groups. In some embodiments, A is —CO₂ M, X is O or NH, and R¹ and or R² is a linear or branched alkylene having from 1 to 7 carbon atoms. Exemplary metal ions, M, include, sodium, potassium, and calcium. Illustrative functional acid containing compounds include dihydroxycarboxylic acids, dihydroxysulphonic acids, dihydroxyphosphonic acids and salts thereof such as dimethylolpropionic acid (DMPA) depicted as follows (or its derivatives from GEO Specialty Chemicals, Inc. under a trade designation such as “DMPA Polyol HA-0135”, “DMPA Polyol HA-0135LV2”, “DMPA Polyol HC-0123” and “DMPA Polyol BA-0132”):

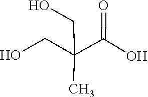

In some embodiments, the amount of functional acid in the polyurethane may be described in terms of the number of millimoles of the functional acid group A (mmol A) per 100 grams of the polyurethane (100 g PU). In this regard, the polyurethane may include between 0.001 and 45 mmol A/100 g PU, 0.1 and 45 mmol A/100 g PU, 1 and 45 mmol A/100 g PU, or between 1 and 25 mmol A/100 g PU. It is believed that the incorporation of a small amount of acid functional groups in the polyurethane may further improve (relative to the polyurethanes of the present disclosure without acid functional groups) adhesion properties as well as the chemical resistance of the material to, for example, polar chemicals.

In one embodiment, the reaction product of the polyester polyol and the isocyanate component further comprise a second polyol, such as a hydrophilic polyol.

The functional acid containing compound and the second polyol may function as chain extenders and chemical crosslinkers. In one embodiment, the reaction product of the polyester polyol and the isocyanate component is derived from 0.5, 1, 5, 10, 15, 20, 25, 30, 35, 40, 45 or 50 wt % of the second polyol and/or the functional acid containing compound.

In one embodiment, the second polyol comprises hydrophilic polymerized units. Such hydrophilic polymerized units may be characterized as having a hydrophilic-lipophilic balance (HLB) of at least 12, 13, 14, 15, 16, 17, 18, 19 or 20. A small amount of such hydrophilic groups can improve the environmental aging results, i.e. the adhesive exhibits less than 2, 1.5, or 1% haze after aging at 65° C. add 90% relative humidity for 800 hours. In some embodiments, the polyurethane comprises at least 0.5, 1.0, or 1.5 w % of polymerized hydrophilic units. The amount of polymerized hydrophilic units is typically less than 10, 9, 8, 7, 6, or 5 wt % of the total polymerized units of the polyurethane. In some embodiments, the polyurethane comprises no greater than 4, 3.5, or 3 wt % of polymerized hydrophilic units.

In some embodiments, the polymerized hydrophilic units are derived from a polyethylene glycol polymer. The polyethylene glycol polymer may be a polyethylene glycol homopolymer or a copolymer of ethylene glycol and a comonomer (e.g. propylene oxide). The copolymer typically comprises at least 50, 60, 70, 80, or 90 wt % of polymerized units of ethylene glycol.

One suitable polyethylene glycol polymer is commercially available from Perstorp under the trade designation “YMERN-120”. The structure of such polymer is as follows:

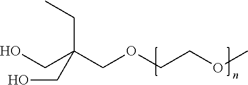

Such material is commonly utilized as a non-ionic dispersing agent for waterborne polyurethane dispersions. However, the presently described polyurethane is predominantly hydrophobic and thus does not comprise a sufficient concentration of hydrophilic groups to render the polyurethane water soluble or water dispersible as evidenced by the IPA/water chemical resistance. When the polyethylene glycol polymer has a terminal group comprising two hydroxyl groups, the polymer can be incorporated into the polymer backbone such that the resulting polyurethane comprises pendent polyethylene glycol polymer units. In contrast, polyethylene glycol polymers having a terminal group on both ends result in the polyethylene glycol polymer unit being present in the polymer backbone, rather than being pendent.

Other commercially available ethylene oxide/propylene oxide block copolymers are available from BASF under the trade designation “PLURONIC”.

In some embodiments, the (e.g. pendent) polymerized hydrophilic units or polyethylene glycol polymer has a molecular weight of at least 200, 300, 400 or 500 g/mole. In some embodiments, the polymerized hydrophilic units or polyethylene glycol polymer has a molecular weight no greater than 2000 or 1500 g/mole.

The polyurethane polymer of the present disclosure may optionally be derived from other components that do not detract from the desired dimensional stability, conformability and/or chemical resistance of the polyurethane.

In some embodiments, the aromatic polyester polyol is reacted with an isocyanate component such that the ratio of hydroxyl equivalents (OH groups) with respect to the NCO isocyanate equivalents (NCO groups) is about 1:1. The hydroxyl content of the resulting polyurethane is no greater than about 0.5 wt %.

In other embodiments, the polyurethane polymers can be prepared by the reaction of a stoichiometric excess of polyisocyanate. The molar ratio of NCO to OH is typically about 1.3 to 1 or 1.2 to 1 or 1.1 to 1. In this embodiment, the NCO terminal groups are typically further reacted with a multi-functional polyol. Suitable multi-functional polyols may include two or more hydroxyl groups such as, for example, branched adipate glycols, trimethylolpropane, 1,2,6-hexanetriol, trimethylolethane, pentaerythritol, dipentaerythritol, tripentaerythritol and the like.

In other embodiments, the polyurethane polymers can be prepared by the reaction of a stoichiometric excess of the polyester polyol. The molar ratio of OH to NCO is typically about 1.3 to 1 or 1.2 to 1 or 1.1 to 1. In this embodiment, the OH terminal groups are typically further reacted with a multi-functional polyisocyanate. Suitable multi-functional polyisocyanates may include two or more isocyanate groups such as, for example, Desmodur N-3300, Desmodur N-3390 and Desmodur N-3400 from Bayer.

In addition to urethane linkages, the polyurethane can contain additional groups as known in the art, provided that such additional groups do not detract from the desired dimensional conformability and/or chemical resistance. In one embodiment, the polyurethane does not contain (terminal) silyl groups and/or meth(acrylate) linkages.

When reacting the polyester polyol component with the isocyanate component, the reaction temperature is typically in the range of from about 60° C. to about 90° C. depending on the selection of respective reactants and selection of catalyst. The reaction time typically ranges from about 2 to about 48 hours.

The polyurethane compositions are typically prepared with a catalyst as known in the art. The amount of catalyst can range up to about 0.5 parts by weight of the polyurethane. In some embodiments, the amount of catalyst ranges from about 0.001 to about 0.05 wt % of the polyurethane. Examples of useful catalysts include, but are not limited to, those selected from the group consisting of tin II and IV salts such as stannous octoate and dibutyltin dilaurate, and dibutyltin diacetate; tertiary amine compounds such as triethyl amine and bis(dimethylaminoethyl) ether, morpholine compounds such as beta, beta′-dimorpholinodiethyl ether, bismuth carboxylates, zinc-bismuth carboxylates, iron (III) chloride, potassium octoate, and potassium acetate.

Solvents can be utilized to control the viscosity of the polyurethane. Examples of useful solvents (which are typically volatile organic compounds) added for this purpose include but are not limited ketones (e.g. methyl ethyl ketone, acetone), tertiary alcohols, ethers, esters (e.g. ethyl acetate), amides, hydrocarbons, chlorohydrocarbons, chlorocarbons, and mixtures thereof.

The resulting polyurethane polymer typically has a number average molecular weight (Mn) of at least 10000, 20000, 30000, 40000, or even 50000 g/mole. The molecular weight is typically at most 100000, 150000, or even 200000 g/mol. The average molecular weight may be determined using techniques known in the art such as gel permeation chromatography.

Pressure Sensitive Adhesives

In one embodiment, the polyurethane polymer and/or the higher molecular weight polyester polyol disclosed above can be used in a pressure sensitive adhesive composition and articles thereof.

The polyurethane polymer disclosed above and/or the higher molecular weight polyester polyol can be crosslinked to achieve an ever higher molecular weight and improved chemical resistance, improved thermal stability and/or stabilization of the dielectric constant of the polymer.

In some embodiments, the adhesives of the present disclosure may optionally include a chemical crosslinking agent. Generally, any suitable chemical crosslinking agent may be used Exemplary chemical crosslinking agents include covalent crosslinkers such as bisamides, epoxies (for example, N,N,N′,-tetraglycidiyl-m-xylenediamine, available from Mitsubishi Gas Chemical Co. Inc, Japan, as the trade designation “TETRAD-X”), melamines, multi-functional amines and aziridines (for example, propylene imine tri-functional polyaziridine, available from PolyAziridine, LLC, Medford, N.J., as the trade designation “PZ-28”; polycarbodiimde, and ionic crosslinking agents such as metal oxides and organo-metallic chelating agents (e.g., aluminum acetylacetonate).

When the polymer (e.g., the polyurethane polymer or the polyester polyol) is prepared from a functional acid containing compound and thereby further comprises acidic groups, the adhesive composition may further comprise a carbodiimide (e.g. polycarbodiimide) crosslinker such as commercially available from Stahl, USA, Calhoun, Ga. Such carbodiimide crosslinkers as well as other acid-reactive compounds can also function as an acid scavenger even in the absence of the polymer comprising acidic groups. These reactions involve the addition of a (e.g. carboxylic) acid group across the carbodiimide to form a urea linkage. Other chemical crosslinkers described above may also function as an acid scavenger. In some embodiments, the adhesive composition further comprises at least 0.1, 0.2, 0.3, 0.4, or 0.5 wt % of a carbodiimide and/or other acid-reactive compound. The concentration of carbodiimide and/or other acid-reactive compound is typically no greater than 5, 4, 3, or 2 wt % of the adhesive composition.

The polyurethane polymers are preferably stable at high temperature and high humidity conditions. However, polyurethane polymers are susceptible to chemical breakdown due to reaction with water. The hydrolysis of the polyurethane polymer can generate alcohols and acids. Acid can further catalyze the hydrolysis process to accelerate the chemical breakdown process. The inclusion of acid-reactive compounds, especially carbodiimide (e.g. polycarbodiimide) and epoxy compounds can reduce such chemical breakdown. In this embodiment, these materials may be characterized as acid traps. The acid traps not only reduce the acid, but also can re-crosslink those acid groups generated during hydrolysis.

As an alternative to, or in addition to chemical crosslinking, the polymers of the present disclosure (i.e., polyurethane polymer and/or polyester polyol polymer) further comprising ethylenically unsaturated groups and/or a multi-(meth)acrylate crosslinker may be crosslinked by subjecting the polymers to gamma, electron beam, or ultraviolet radiation (with or without a photoinitator) radiation. In this embodiment the polymers may be free of chemical crosslinking agents (or residues thereof).

In some embodiments, adhesives described herein comprise from 0.1 to 2, 3, 4, 5, 6, 7, 8, 9, or 10 wt % of multi-(meth)acrylate crosslinker(s) such as urethane (meth)acrylate oligomer(s) and/or the hydrophilic multi-functional (meth)acrylate monomers described above. Crosslinking can increase the gel content of the adhesive. For example in the absence of (e.g. multi-(meth)acrylate) crosslinker, the gel content may range from 5 to 10%. However, when (e.g. multi-(meth)acrylate crosslinker(s)) is present, the gel content is typically greater than 10, 15, 20, 25, 30, 35, 40, 45, or 50% ranging up to 60 or 70%.

In some embodiments, the pressure sensitive adhesive comprises the polyurethane polymer described herein dissolved in a non-aqueous organic solvent. The organic solvent content typically ranges from about 2 wt % to 98 wt %. By non-aqueous, it is meant that the liquid medium contains less than 3, 2, or 1 wt % water.

In addition to the polyurethane polymer and/or the polyester polyol polymer, the pressure sensitive adhesive composition may optionally include one or more additives to impact the performance and/or properties of the PSA composition. Such additives include tackifiers, adhesion promoters, plasticizers, additional tackifiers, crosslinking agents, UV stabilizers, antistatic agents, colorants, antioxidants, fungicides, bactericides, organic and/or inorganic filler particles such as (e.g. fumed) silica and glass bubbles, (e.g. chemical) foaming agents, thixotropic agents, impact resistance aids, flame retardants (e.g. zinc borate), and the like.

In some embodiments, the pressure sensitive adhesive composition comprises tackifiers and/or plasticizers to adjust the adhesion. Exemplary plasticizers include: hydrocarbon oils (e.g., those that are aromatic, paraffinic, or naphthenic), hydrocarbon resins, polyterpenes, rosin esters, phthalates (e.g., terephthalate), phosphates esters, phosphates (e.g., tris(2-butoxyethyl) phosphate), dibasic acid esters, fatty acid esters, polyethers (e.g., alkyl phenyl ether), epoxy resins, sebacate, adipate, citrate, trimellitate, dibenzoate, or combinations thereof. Exemplary tackifiers include: rosins and their derivatives (e.g., rosin esters); polyterpenes and aromatic-modified polyterpene resins; coumarone-indene resins; hydrocarbon resins, for example, alpha pinene-based resins, beta pinene-based resins, limonene-based resins, aliphatic hydrocarbon-based resins, aromatic-modified hydrocarbon-based resins; or combinations thereof. Non-hydrogenated tackifiers resins are typically more colorful and less durable (i.e., weatherable). Hydrogenated (either partially or completely) tackifiers may also be used. Examples of hydrogenated tackifiers include, for example: hydrogenated rosin esters, hydrogenated acids, hydrogenated aromatic hydrocarbon resins, hydrogenated aromatic-modified hydrocarbon-based resins, hydrogenated aliphatic hydrocarbon-based resins, or combinations thereof. Examples of additional synthetic tackifiers include: phenolic resins, terpene phenolic resins, poly-t-butyl styrene, acrylic resins, or combinations thereof. In one embodiment, the total amount of tackifier and/or plasticizer of the adhesive composition is typically no greater than 50, 40, 30, 20, 15, 10, or 5 wt % solids of the total adhesive composition. In other embodiments, the pressure sensitive adhesive composition comprises little or no (i.e. zero) tackifiers and/or plasticizers. In this embodiment, the adhesive composition comprises no greater than 4, 3, 2, 1, 0.5, 0.1, or 0.05 wt % of tackifier and/or plasticizer.

When it is desired for the pressure sensitive adhesive composition to be transparent, the adhesive is typically free of fillers having a particle size greater than 100 nm that can detract from the transparency of the adhesive composition. In this embodiment, the total amount of filler of the adhesive composition is no greater than 10, 9, 8, 7, 6, 5, 4, 3, or 2 wt % solids of the adhesive composition. In some favored embodiments, the adhesive composition comprises no greater than 1, 0.5, 0.1, or 0.05 wt % of a filler. However, in other embodiments, the pressure sensitive adhesive may comprise higher amounts of inorganic oxide filler such as fumed silica.

In some embodiments, the pressure sensitive adhesive comprises colorants such as pigments and dyes including titania and carbon black. The concentration of such pigments and dyes can range up to about 20 wt % of the total adhesive composition.

Exemplary anti-oxidants include phenols, phosphites, thioesters, amines, polymeric hindered phenols, copolymers of 4-ethyl phenols, reaction product of dicyclopentadiene and butylene, or combinations thereof. Additional examples include phenyl-alpha-naphthylamine, phenyl-beta-naphthylamine, phenyl-beta-naphthylene, 2,2′-methylene bis (4-methyl-6-tertiary butyl phenol), phenolic-based anti-oxidants sold under the trade designation “CIBA IRGANOX 1010” by from Ciba Specialty Chemicals Corp., Tarrytown, N.Y., or combinations thereof.

UV-stabilizers such as UV-absorbers are chemical compounds that can intervene in the physical and chemical processes of photoinduced degradation. Exemplary UV-absorbers include: benzotriazole compound, 5-trifluoromethyl-2-(2-hydroxy-3-alpha-cumyl-5-tert-octylphenyl)-2H-benzotriazole, or combinations thereof. Other exemplary benzotriazoles include: 2-(2-hydroxy-3,5-di-alpha-cumylphehyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole, or combinations thereof. Additional exemplary UV-absorbers include 2(-4,6-diphenyl-1-3,5-triazin-2-yl)-5-hexcyloxy-phenol, and those available from Ciba Specialty Chemicals Corp. sold under the trade designations “CIBA TINUVIN 1577” and “CIBA TINUVIN 900”. In addition, UV-absorber(s) can be used in combination with hindered amine light stabilizer(s) (HALS) and/or anti-oxidants. Exemplary HALSs include those available from Ciba Specialty Chemicals Corp. Basel, Switzerland sold under the trade designations “CIBA CHIMASSORB 944” and “CIBA TINUVIN 123”.

The additives may be present in an amount from 0.5% by weight to 5% by weight based upon the weight of the total pressure sensitive adhesive. Certain additives may be of lower weight percent, e.g., a pigment may be added at less than 0.05% or even less than 0.005% by weight based on 100 parts of the high molecular weight polymer.

In one embodiment, a compound comprising one or more hydroxy groups and one or more ethylenically unsaturated groups is utilized as a light sensitive derivative during the preparation of the polyurethane. The hydroxyl group reacts with the polyisocyanate incorporating ethylenically unsaturated groups into the polyurethane. In some embodiments, compound having a single hydroxyl group and a single ethylenically unsaturated group can be utilized such as hydroxyethyl acrylate (HEA). In this embodiment, an isocyanate group is bonded to the polyurethane polymer backbone and the opposing end of the diisocyanate is bonded to the hydroxyl group of the compound resulting in a terminal ethylenically unsaturated group. In other embodiments, the compound has at least two hydroxy groups and at least two ethylenically unsaturated groups, such as bisphenol A glycerolate dimethacrylate (BAGDM). In this embodiment, the compound functions as a polyol (i.e. diol) and is thereby incorporated into the polyurethane backbone. The ethylenically unsaturated groups are pendent with respect to the polyurethane backbone.

Various compounds comprising one or more hydroxy groups and one or more ethylenically unsaturated groups can be utilized during the preparation of the polyurethane. Such compound can be aliphatic or aromatic. Other representative compounds available from Nagase ChemteX Corporation, Osaka, Japan include for example epoxy acrylate form 1,6 hexane diol, available as DA-212; epoxy acrylate form 1,4 hexane diol, available as DA-214L.

In one embodiment, the pressure sensitive adhesive comprises 0.1 to 5% by weight of at least one of these light sensitive derivatives.

In one embodiment, the pressure sensitive adhesive composition has good chemical resistance. For example, in some embodiments, the pressure sensitive adhesive does not detach from the substrate, dissolve or swell when placed in oleic acid and/or a 70% isopropyl alcohol aqueous solution after 72 hours at 70° C. Additionally, or alternatively, in some embodiments, the pressure sensitive adhesive does not detach from its substrate, dissolve or swell when placed in an oil (such as cooking oil or fingerprint oil) after 72 hours at 70° C. Additionally, or alternatively, in some embodiments, the pressure sensitive adhesive article does not detach from its substrate, dissolve or swell when placed in sunscreen (e.g., Sport Performance, SPF 30 from Banana Boat, available from Amazon) after 72 hours at 70° C.

The pressure sensitive adhesive composition of the present disclosure has a glass transition temperature (Tg) of below room temperature. In one embodiment, the pressure sensitive adhesive composition has a Tg below 0, −5, −10, −20, −25, −30, or even −40° C. as determined by differential scanning calorimetry (DSC) or dynamic mechanical thermal analysis (DMA).

In order to perform as a pressure sensitive adhesive the adhesive should have quick tack. In one embodiment, the pressure sensitive adhesive composition has a modulus G′ of no more than 300, 250, or even 200 kPa at 25° C. and a frequency of 1 hertz.

In some embodiments, the pressure sensitive adhesive composition has a storage modulus G′ as can be measured by Dynamic Mechanical Analysis (as further described in the examples) of more than 50, 100, 150, or even 200 kPa at 25° C. and a frequency of 1 hertz. The storage modulus decreases with increasing temperature. In some embodiments, the pressure sensitive adhesive composition has a storage modulus G′ at 70° C. and a frequency of 1 hertz of at least 25, 30, 40, 50, 60, 70, or even 80 kPa.

The pressure sensitive adhesive composition should have sufficient flow to not only comply with features on the surface, but also wet the surface. Compliance of the pressure sensitive adhesive is the ability of the adhesive to deform quickly, and to comply to the sharp edge of features for example, an ink step contour, such as found in a display component. The ability of the adhesive to flow can be measured using DMA. Pressure sensitive adhesives are viscoelastic materials. Covering a relatively high ink step with a relatively thin adhesive (150 microns or less) requires a shift in the viscous balance (captured in G″) vs. elastic balance (captured in G′), herein, the tan delta value from the DMA measurement is the ratio of the viscous component (shear loss modulus G″) of the pressure sensitive adhesive to the elastic component (shear storage modulus G′) of the adhesive. At temperatures above the glass transition temperature of the pressure sensitive adhesive, higher tan delta values indicate better adhesive flow. In one embodiment, the pressure sensitive adhesive of the present disclosure has a tan delta at room temp of less than 1, 0.5, 0.3 and at tan delta at 60° C. of at least 0.5, 0.7, or 1, when measured as disclosed in the test method below.

The adoption of post-curable adhesives can initially (before final cure) have lower storage modulus, and good flow, particularly at high temp/autoclave process. This would significantly improve the compliance of the adhesive. After lamination, post curing will increase the modulus and cross-linking level of the pressure sensitive adhesive for better adhesion and cohesive strength. As a result, the tan deltas of such adhesives would significantly decrease after curing. In one embodiment, the un-cured pressure sensitive adhesive retains a tan delta value of between about 0.4 and about 1.5 over a temperature range of between about 25° C. and about 85° C. and a frequency of 1 Hz. In one embodiment, the cured pressure sensitive adhesive retains a tan delta value of between about 0.4 and about 0.8 over a temperature range of between about 25° C. and about 85° C. and a frequency of 1 Hz.

The pressure sensitive adhesive has sufficient adhesion to substrates of interest. In one embodiment, the pressure sensitive adhesive composition of the present disclosure has a 180° peel to stainless steel of at least 1.30, 1.40, 1.50, or even 1.60 N/mm at a peel rate of 300 mm/minute after a 24 hour dwell at ambient conditions. Alternatively, or additionally, in one embodiment, the pressure sensitive adhesive composition of the present disclosure has a 180° peel to float glass of at least 3, 5, 10, or even 15 N/cm at a peel rate of 60 mm/minute after a 24 hour dwell at ambient conditions.

When used in optical assemblies, the pressure sensitive adhesive needs to be suitable for optical applications, such as being optically clear. In one embodiment, the pressure sensitive adhesive over the wavelengths from 460 to 720 nm has a transmission of at least 90, or even 95%. The pressure sensitive adhesive composition may have, per millimeter thickness, a transmission of greater than about 85% at 460 nm, greater than about 90% at 530 nm, and greater than about 90% at 670 nm. These transmission characteristics provide for uniform transmission of light across the visible region of the electromagnetic spectrum which is important to maintain the color point in full color displays. Haze is the percentage of transmitted light that deviates from the incident beam by more than 2.5°. In one embodiment, the optically clear pressure sensitive adhesive composition should have a low percent haze, for example, a haze of less than 4, 2, 1 or even 0.5% across the visible region of the electromagnetic spectrum (e.g., 460 to 720 nm). In one embodiment, the haze and the transmission can be determined using, for example, ASTM-D 1003-92. In CIELAB color space, L* defines the lightness, a* defines red/green, and b* defines blue/yellow. In optical applications, the b* parameter is selected since it is a measure of the blue-yellow as defined in the CIE (International Commission on Illumination 1976 Color Space, with the lower the b* value the more desirable. In one embodiment, the pressure sensitive adhesive composition of the present disclosure has a b* of less than 2, 1, or even 0.5 (when corrected for the support). Additionally, in optical applications, the layer of the pressure sensitive adhesive typically has a refractive index that matches or closely matches that of the substantially transparent substrate. For example, the adhesive layer may have a refractive index of from about 1.4 to about 1.7.

Articles

A laminating tape can be formed by coating the pressure sensitive adhesive compositions on a backing or release liner using conventional coating techniques. For example, these compositions can be applied by methods such as roller coating, flow coating, dip coating, spin coating, spray coating knife coating, and die coating. Coating thicknesses may vary. The composition may be of any desirable concentration for subsequent coating, but is typically at least 20 or 25 wt % polymer solids in an organic solvent. In some embodiments, the coating comprises to greater than about 60 wt % polymer solids (e.g., polyurethane polymer or higher molecular weight polyester polyol). The desired concentration may be achieved by further dilution of the coating composition, or by partial drying. The coating thickness may vary depending on the desired thickness of the pressure sensitive adhesive layer.

The thickness of the pressure sensitive adhesive layer is typically at least 10, 15, 20, or 25 microns (1 mil) and ranging up to 500 microns (20 mils) thickness. In some embodiments, the thickness of the pressure sensitive adhesive layer is no greater than 400, 300, 200, or 100 microns. The pressure sensitive adhesive can be coated in single or multiple layers.

The pressure sensitive adhesive composition may be coated upon a variety of flexible and inflexible backing materials using conventional coating techniques to produce a single coated or double coated pressure sensitive adhesive tape. The tape may further comprise a release material or release liner. For example, in the case of a single-sided tape, the side of the backing surface opposite that where the adhesive is disposed is typically coated with a suitable release material. Release materials are known and include materials such as, for example, silicone, polyethylene, polycarbamate, polyacrylics, and the like. For double coated tapes, a second layer of adhesive is disposed on the opposing surface of the backing surface. The second layer may also comprise the polyurethane pressure sensitive adhesive as described herein or a different adhesive composition.

Flexible substrates are defined herein as any material which is conventionally utilized as a tape backing or may be of any other flexible material. Examples include, but are not limited to polymeric films, woven or nonwoven fabrics; metal foils, foams (e.g., polyacrylic, polyethylene, polyurethane, neoprene), and combinations thereof (e.g. metalized polymeric film). Polymeric films include for example polypropylene (e.g. biaxially oriented), polyethylene (e.g. high density or low density), polyvinyl chloride, polyurethane, polyester (polyethylene terephthalate), polycarbonate, polymethyl(meth)acrylate (PMMA), polyvinylbutyral, polyimide, polyamide, fluoropolymer, cellulose acetate, cellulose triacetate, and ethyl cellulose. The woven or nonwoven fabric may comprise fibers or filaments of synthetic or natural materials such as cellulose (e.g. tissue), cotton, nylon, rayon, glass, ceramic materials, and the like.

A substrate may be bonded by the pressure sensitive adhesive or laminating tape described herein. The substrate may comprise the same materials as just described for the backing.

One method of bonding comprises providing a first substrate and contacting a surface of the first substrate with the pressure sensitive adhesive (e.g. laminating tape). In this embodiment, the opposing surface of the pressure sensitive adhesive is typically temporarily covered by a release liner.

In other embodiments, the method further comprises contacting the opposing surface of the pressure sensitive adhesive to a second substrate. The first and second substrate may be comprised of various materials as previously described such as metal, an inorganic material, an organic polymeric material, or a combination thereof.

In some methods of bonding, the substrate, pressure sensitive adhesive, or combination thereof may be heated to reduce the storage modulus (G′) and thereby increase the conformability. The substrate and/or pressure sensitive adhesive may be heated to a temperature up to 30, or 35, or 40, or 45, or 50, or 55, or 60, or 65 or 70° C. Optionally, a pressure of 3 kPa-5 kPa may be used. In one embodiment, the substrate and/or pressures sensitive adhesive is heated by means of a hot air gun, or an autoclave oven with optional pressure.

The pressure sensitive adhesive, and laminating tapes described herein are suitable for use in the areas of electronics, appliances, and general industrial products. In some embodiments, the pressure sensitive adhesive and laminating tapes can be utilized in (e.g. illuminated) displays that can be incorporated into household appliances, automobiles, computers (e.g. tablets), and various hand-held devices (e.g. phones).

The presently disclosed adhesive composition can be laminated to solid substrates at ambient temperature (25° C.) and provide good high temperature/humidity stability and chemical resistance. The superior oil (e.g. oleic acid), sunscreen, cooking oils, fingerprint oils, and alcohol resistance of the presently disclosed adhesive composition make it attractive for various applications including automotive, aerospace, electronics and appliance markets where maintaining adhesive bond strength under high temperature/humidity and chemical environment are of importance.

In some embodiments, the pressure sensitive adhesive and laminating tapes described herein are suitable for bonding internal components or external components of an illuminated display devices such as liquid crystal displays (“LCDs”) and light emitting diode (“LEDs”) displays such as cell phones (including Smart phones), wearable (e.g. wrist) devices, car navigation systems, global positioning systems, depth finders, computer monitors, notebook and tablet computer displays.

In one embodiment, the pressure sensitive adhesive disclosed here can be used in capacitive touch technology applications, including mobile hand-helds, netbooks and laptop computers. Compared to other touch technologies, capacitive touch enables very sensitive response as well as features such as multi-touch. Optically clear adhesives (OCAs) are often used for bonding purposes (e.g., attachment of different display component layers) in the capacitive touch panel assembly.

Not only do OCAs provide mechanical bonding, but they also can greatly increase the optical quality of the display by eliminating air gaps that reduce brightness and contrast. The optical performance of a display can be improved by minimizing the number of internal reflecting surfaces, thus it may be desirable to remove or at least minimize the number of air gaps between optical elements in the display.

In one embodiment, the pressure sensitive adhesive of the present disclosure may provide good wetting (i.e., no bubbles or air gaps) of display components, which may include raised integrated circuits, ink steps, flex connectors, and other 3-dimensional features. Such wetting may be achieved by the pressure sensitive adhesives of the present disclosure, which can flow more easily upon heating.

In one embodiment, during manufacture, the pressure sensitive adhesive composition is laminated between two substrates as a multilayered sheet or web. Smaller units are then cut (for example die cut) from the multilayered sheet or web for subsequent use. Thus, in some embodiments, it is important that the pressure sensitive should have good dimensional stability, such that there is minimal to no, creeping (or leaking) of the pressure sensitive adhesive from a cut edge of the laminated article. Such good dimensional stability may be achieved by the pressure sensitive adhesives of the present disclosure, which can have a high modulus (G′) at room temperature, especially after curing.

Exemplary embodiments of the present disclosure include, but are not limited to, the following:

Embodiment one: A polyester polyol comprising:
a first reaction product of
(a) a Component A, wherein the Component A is a phthalic acid, a phthalic anhydride or mixtures thereof,
(b) a Component B, wherein the Component B is a dimer fatty acid, a dimer fatty acid diol or mixtures thereof, and
(c) a Component C, wherein the Component C is an aliphatic diol, an aromatic diol, or mixtures thereof, wherein Component C comprises 2 to 10 carbon atoms and optionally at least one catenated heteroatom, wherein the heteroatom is selected from O, S, and N.

Embodiment two: The polyester polyol of embodiment one, wherein the average number of carbons in the dimer fatty acid or the dimer fatty acid diol is at least 20 and no more than 45.

Embodiment three: The polyester polyol of any one of the previous embodiments derived from 20 to 60 wt % of the Component A, 10 to 60 wt % of the Component B, and 20 to 60 wt % of the Component C.

Embodiment four: The polyester polyol of any one of the previous embodiments, wherein the Component C comprises at least one of 1,4-butanediol, 1,6-hexanediol, and 1,8-octanediol.

Embodiment five: The polyester polyol of any one of the previous embodiments, wherein the first reaction product further comprises no more than 25 wt % of a second aliphatic or aromatic diol, wherein the second aliphatic or aromatic diol is selected from ethylene glycol, an aliphatic diol comprising more than 10 carbon atoms or aromatic diol comprising more than 10 carbon atoms.

Embodiment six: The polyester polyol of any one of the previous embodiments, wherein the first reaction product further comprises no more than 25 wt % of a second diacid.

Embodiment seven: The polyester polyol of any one of the previous embodiments having a Tg below 15° C.

Embodiment eight: The polyester polyol of any one of the previous embodiments, wherein the polyester polyol is amorphous.

Embodiment nine: The polyester polyol of any one of embodiments one to seven, wherein the polyester polyol is semi-crystalline.

Embodiment ten: The polyester polyol of any one of the previous embodiments, having a number average molecular weight of at least 1000 g/mole and not more than 10,000 g/mol.

Embodiment eleven: The polyester polyol of any one of embodiments one to nine, having a number average molecular weight of greater than 10,000 g/mol and at most 100,000 g/mol.

Embodiment twelve: A polyurethane polymer comprising a second reaction product of (a) the polyol according to any one of embodiments one to nine, and (b) a polyisocyanate component.

Embodiment thirteen: The polyurethane polymer of embodiment twelve, wherein the polyisocyanate component comprises an aliphatic polyisocyanate, an aromatic polyisocyanate, or a mixture thereof.

Embodiment fourteen: The polyurethane polymer of any one of embodiments twelve to thirteen, wherein the second reaction product is derived from 55-99 wt % of the polyester polyol.

Embodiment fifteen: The polyurethane polymer of any one of embodiments twelve to fourteen, wherein the second reaction product is derived from 1 to 35 wt % of the polyisocyanate component.

Embodiment sixteen: The polyurethane polymer of any one of embodiments twelve to fifteen, wherein the second reaction product further comprises a functional acid.

Embodiment seventeen: The polyurethane polymer of embodiment sixteen, wherein the functional acid containing compound is represented by the formula (HX)₂R¹A and/or (HX)₂R²(A)₂; wherein A is a functional acid group selected from —CO₂ M, —OSO₃ M, —SO₃ M, —OPO(OM)₂, —PO(OM)₂, wherein M is H or a cation and has a valency of m, wherein m is 1, 2, or even 3; X is O, S, NH or NR, wherein R is an alkylene group comprising 1 to 10 carbon atoms; and R¹ is an organic linking group having a valency of 3 and R² is an organic linking group having a valency of 4, wherein R¹ and R² comprise 1 to 50 carbon atoms, optionally includes one or more tertiary nitrogen, ether oxygen, or ester oxygen atoms, and is free from isocyanate-reactive hydrogen containing groups.

Embodiment eighteen: The polyurethane polymer of seventeen, wherein A is —CO₂ M, X is O or NH, and R¹ is an alkylene having from 1 to 7 carbon atoms.

Embodiment nineteen: The polyurethane polymer of any one of embodiments sixteen to eighteen, wherein the second reaction product is derived from 0.01 to 5 wt % of the functional acid containing compound.

Embodiment twenty: The polyurethane polymer of any one of embodiments twelve to nineteen, wherein the polyurethane polymer has a number average molecular weight of at least 10,000 g/mol and at most 200,000 g/mol.

Embodiment twenty-one: A pressure sensitive adhesive comprising the polyester polyol of embodiment eleven.

Embodiment twenty-two: A pressure sensitive adhesive comprising the polyurethane polymer of any one of embodiments twelve to twenty.

Embodiment twenty-three: The pressure sensitive adhesive composition of any one of embodiments twenty-one to twenty-two, wherein the composition further comprises a chemical crosslinking agent.

Embodiment twenty-four: The pressure sensitive adhesive composition of embodiment twenty-three, wherein the chemical crosslinking agent comprises at least one of an organo-metallic chelating agent, an epoxy, an aziridine, polycarbodiimde, and combinations thereof.

Embodiment twenty-five: The pressure sensitive adhesive composition of any one of embodiments twenty-one to twenty-four, wherein the pressure sensitive adhesive composition further comprises 0.1 to 5% by weight of a light sensitive derivative.

Embodiment twenty-six: The pressure sensitive adhesive composition of any one of embodiments twenty-one to twenty-five, wherein the pressure sensitive adhesive composition further comprises a tackifier.

Embodiment twenty-seven: The pressure sensitive adhesive composition of any one of embodiments twenty-one to twenty-six, wherein the pressure sensitive adhesive composition further comprises a plasticizer.

Embodiment twenty-eight: The pressure sensitive adhesive composition of any one of embodiments twenty-one to twenty-seven, wherein the pressure sensitive adhesive composition further comprises a filler.

Embodiment twenty-nine: The pressure sensitive adhesive composition of any one of embodiments twenty-one to twenty-eight, wherein pressure sensitive adhesive composition has a 180° peel to glass of at least 3 N/cm at room temperature and a peel rate of 60 mm/minute.

Embodiment thirty: The pressure sensitive adhesive composition of any one of embodiments twenty-one to twenty-nine, wherein the pressure sensitive adhesive composition has a glass transition temperature below 0° C.

Embodiment thirty-one: The pressure sensitive adhesive composition of any one of embodiments twenty-one to thirty, wherein the pressure sensitive adhesive composition has a modulus of no more than 300 kPa at 25° C. and a frequency of 1 hertz.

Embodiment thirty-two: The pressure sensitive adhesive composition of any one of embodiments twenty-one to thirty-one, wherein the pressure sensitive adhesive has at least 90% transmission over 460 to 720 nm.

Embodiment thirty-three: The pressure sensitive adhesive composition of any one of embodiments twenty-one to thirty-two, wherein the pressure sensitive adhesive has haze of less than 1%.

Embodiment thirty-four: The pressure sensitive adhesive composition of any one of embodiments twenty-one to thirty-three, wherein the pressure sensitive adhesive retains a tan delta value of between about 0.4 and about 1.5 over a temperature range of between about 25° C. and about 85° C. and a frequency of 1 Hz.

Embodiment thirty-five: The pressure sensitive adhesive composition of any one of embodiments twenty-one to thirty-four, wherein the pressure sensitive adhesive retains a tan delta value of between about 0.4 and about 0.8 over a temperature range of between about 25° C. and about 85° C. and a frequency of 1 Hz.

Embodiment thirty-six: A laminating tape comprising

a substrate; and

a layer of a pressure sensitive adhesive composition according to embodiments twenty-one to thirty-five disposed on a major surface of the substrate.

Embodiment thirty-seven: The laminating tape of embodiment thirty-six, wherein the substrate is a backing or a release liner.

Embodiment thirty-eight: The laminating tape of embodiments thirty-six and thirty-seven wherein the pressure sensitive adhesive composition is disposed on both major surfaces of the substrate.

Embodiment thirty-nine: A method of bonding comprising
providing a first substrate,
contacting a surface of the first substrate with the pressure sensitive adhesive composition of embodiments twenty-one to thirty-five.

Embodiment forty: The method of embodiment thirty-nine further comprising contacting an opposing surface of the pressure sensitive adhesive composition to a second substrate.

Embodiment forty-one: The method of embodiments thirty-nine to forty wherein the first and second substrate are comprised of a metal, an inorganic material, an organic polymeric material, or a combination thereof.

Embodiment forty-two: The method of embodiments thirty-nine to forty-one wherein the pressure sensitive adhesive composition is heated after contacting the first substrate.

### EXAMPLES

Unless otherwise noted, all parts, percentages, ratios, etc. in the examples and the rest of the specification are by weight, and all reagents used in the examples were obtained, or are available, from general chemical suppliers such as, for example, MilliporeSigma Company, Saint Louis, Mo., or may be synthesized by conventional methods.

These abbreviations are used in the following examples: FT-IR=Fourier transform infrared spectrometry; g=grams, min=minutes, h=hour, ° C.=degrees Celsius, and ml=milliliter.

Materials Table

| Chemicals | Description | Source |
|---|---|---|
| PH-56 | Polyester Polyol OH = 55.5 mgKOH/g | Stepan Company, Northfield, IL |
| HDI | Hexamethylene diisocyanate, under the | Bayer Corporation, Pittsburgh, PA |
| | trade name DESMODUR H | |
| MEK | Methyl ethyl ketone, solvent | Avantor Performance Materials, Inc |
| | | Center Valley, PA |
| DBTDA | Dibutyltin diacetate | MilliporeSigma, St. Louis, MO |
| PA | Phthalic anhydride | MilliporeSigma, St. Louis, MO |
| HDO | 1,6-Hexanediol | Alfa Aesar, Ward Hill, MA |
| DMPA | Dimethylolpropionic acid | MilliporeSigma, St. Louis, MO |
| BAGA | Bisphenol A glycerolate (1 | MilliporeSigma, St. Louis, MO |
| | glycerol/phenol) diacrylate | |
| BHT | Butylated hydroxytoluene | MilliporeSigma, St. Louis, MO |
| Pripol 1009 | Dimer fatty acid | Croda Inc, Edison, NJ |
| Xylene | Solvent | EMD Millipore Corporation, |
| | | Billerica MA |
| Ti(OC4H9)4 | Tetrabutyl orthotitanate | TCI, Tokyo, Japan |
| Ymer N120 | Polymer linear difunctional | Perstorp polyol Inc, Toledo, OH |
| | polyethylene glycol monomethylether | |
| CN983 | Aliphatic polyester-based urethane | Sartomer, Exton, PA |
| | diacrylate oligomer | |
| Irgacure ®TPO | solid photo initiator | BASE SE, Ludwigshafen, Germany |
| KbM-403 | 3-Glycidoxypropyl trimethoxysilane | Shin-Etsu Silicones of America, Inc., |
| | | Akron, OH |
| Permutex | Polycarbodiimide crosslinker | Stahl (USA), Inc., Peabody, MA |
| XR5580 | | |
| Tetrad-X | N,N,N′,-tetraglycidiyl-m-xylenediamine | Mitsubishi Gas Chemical Co. Inc, |
| | | Japan |

Characterization Methods

Method for Chemical Resistance Test

Samples were prepared by slitting test strips 0.5 inch×0.5 inch (1.27 cm×1.27 cm) from each of adhesive article samples prepared. Then, release liner on one surface was removed and the test strips were attached (stuck) to the bottom of a petri dish. The release liner on the second, exposed surface of the test strips was removed and the petri dish containing the attached sample test strips were set aside to dwell at room temperature (about 23° C.) for 15 mins.

The test strips were then submerged in either oleic acid or a mixture of isopropyl alcohol and water at a weight ratio of 70:30 (IPA/H₂O) at 70° C. for 8 hrs. The resistance of the adhesive sample to oleic acid or IPA/H₂O mixture was rated using the following guidelines and reported.

TABLE 1

| | Chemical Resistance |
|---|---|
| Observation | Rating |
| Adhesive sample came off the petri dish or | 1 |
| dissolved completely | |
| Adhesive sample partially detached or dissolved | 3 |
| along the edge | |
| Adhesive sample did not detach or dissolve or | 4 |
| swell, but become slight white hazy | |
| Adhesive sample did not detach or dissolve or | 5 |
| swell and stayed clear | |

Initial Peel Adhesion Strength

The adhesive side of the adhesive tape examples was laminated onto a 2 mil (about 50 micron) thick polyethyleneterephthalate (PET), then slit into test strips measuring 5 mm×12.7 mm. Two replicates were prepared for each adhesive type/panel. The liner from each example was removed and the exposed adhesive surface of the adhesive tape was adhered along the length of a stainless-steel plate (Type 304 having a bright annealed finish, obtained from ChemInstruments, Incorporated, Fairfield, Ohio) and rolled down 5 times. The plate was cleaned prior to applying the tape by wiping with acetone once then with heptane three times using a tissue paper (trade designation KIMWIPE the tape sample by first, available from Kimberly-Clark Corporation, Irving, Tex.). After being conditioned for 24 h at 50% RH at room temperature, the test samples were dwelled for 72 h at 65° C. and 90% RH and then returned to a temperature-controlled room for 24 hours prior to adhesion testing. The peel adhesion strength was evaluated using a tensile tester (MTS Insight, available from MTS Systems, Corporation, Eden Prairie, Minn.) equipped with 1000 N load cell, using a crosshead speed of 300 mm/min, at an angle of 180° with the test specimen held in the bottom clamp and the tail in the top clamp. The peel adhesion and the failure mode were recorded.

Polymer Molecular Weight Measurement

The molecular weight distribution of the adhesive composition was characterized using gel permeation chromatography (GPC). The GPC instrumentation, which was obtained from Waters Corporation (Milford, Mass., USA), included a high-pressure liquid chromatography pump (Model 1515HPLC), an auto-sampler (Model 717), a UV detector (Model 2487), and a refractive index detector (Model 2410). The chromatograph was equipped with two 5 micrometer PLgel MIXED-D columns available from Varian Inc. (Palo Alto, Calif., USA).

Samples of polymeric solutions were prepared by dissolving dried polymer samples in tetrahydrofuran at a concentration of 1.0 percent (weight) and filtering through a 0.2 micrometer polytetrafluoroethylene filter that is available from VWR International (West Chester, Pa., USA). The resulting samples were injected into the GPC and eluted at a rate of 1 milliliter per minute through the columns maintained at 35° C. The system was calibrated with polystyrene standards using a linear least squares analysis to establish a standard calibration curve. The weight average molecular weight (Mw) and the polydispersity index (weight average molecular weight divided by number average molecular weight (Mn)) were calculated for each sample against this standard calibration curve.

Tg as Measured by DSC

The Tg of the polyurethane adhesive was measured by TA Instruments Q 200 Differential Scanning Calorimeter (DSC) in the temperature range from −50 to 150° C. with a heating rate of 10° C./min under nitrogen atmosphere.

Storage Modulus (G′)

Dynamic mechanical analysis (DMA) of each sample was accomplished using an ARES G2 parallel plate rheometer (TA Instruments) to characterize the physical properties of each sample as a function of temperature. For each sample, approximately 0.1 g of polymer material was centered between 8 mm diameter parallel plates of the rheometer and compressed until the edges of the sample were uniform with the edges of the top and bottom plates. The furnace doors that surround the parallel plates and shafts of the rheometer were shut and the temperature was raised to 100° C. and held for 5 minutes to relax any residual stress. Axial force was then set at 0, to maintain contact between the material and the plates. The temperature was set to −50° C., and then temperature was ramped from −50° C. to 200° C. at 5° C./min while the parallel plates were oscillated at a frequency of 1 Hz and an initial strain amplitude of 0.15%. The strain was increased by 50% of the current value whenever the measured torque dropped below 1 g-cm, with a maximum allowed strain amplitude of 10%. The storage modulus (G′) at 25° C. is reported.

### Example 1. Synthesis of Polyester Polyol

Polyester polyol was prepared by charging the required amounts of phthalic anhydride (74.05 g), Pripol 1009 (66.16 g), 1,6-HDO (80.8 g), Ti(OC4H9)4 (100 ppm based on solid) and 120 ml xylene into a 500-mL round-bottom flask equipped with heating mantle, mechanical stirrer, stainless-steel nitrogen sparge tube, thermocouple, temperature controller, and water-cooled condenser. The reactor contents were heated under a slow nitrogen sparge up to 190° C. The reactor contents were azeotropically distilled at 190° C. for 8 hours until around 13 ml water was collected. Finally, the reaction mixture was vacuumed at 100 torr for 4 hours to obtain viscous liquid polyol. The OH number of the polyol was 37.4 mg KOH/g according to ASTM E222-17.

### Example 2. Synthesis of Polyester Polyol

Polyester resin was prepared by charging the required amounts of phthalic anhydride (74.05 g), Pripol 1009 (66.16 g), 1,6-HDO (73.27 g), Ti(OC₄H₉)₄ (100 ppm based on solid) and 120 mL xylene into a 500-mL round-bottom flask equipped with heating mantle, mechanical stirrer, stainless-steel nitrogen sparge tube, thermocouple, temperature controller, and water-cooled condenser. The reactor contents were heated under a slow nitrogen sparge up to 190° C. The reactor contents were azeotropically distilled at 190° C. for 8 hours until 13 ml water was collected. Finally, the reaction mixture was vacuumed at 100 torr for 4 hours to obtain highly viscous liquid polyester. The Mn of the polyester was around 41000 grams/mole.

### Example 3: Synthesis of Polyurethane Adhesive

To a resin reaction vessel equipped with mechanical stirrer, a condenser and a nitrogen inlet were added 100.0 g polyester polyol obtained from Example 1, 50 g of MEK, 0.05 g of DBTDA, 0.53 g of DMPA, and 6.20 g Desmodur H. The reaction was carried at 80° C. with stirring until no free NCO group was observed by FT-IR. During the reaction, a certain amount of MEK was added to adjust the viscosity, resulting in clear and transparent polyurethane solution in MEK with 45 wt % solid. The GPC data were as follows: Mn=45.6 kDaltons, Mw=131.9 kDaltons, Pd=2.89. The solution was coated on a RF02N liner (silicone coated polyester release liner available from SKC Haas, Cheonan, Korea) and dried at 70° C. for 1 h to obtain adhesive tape.

### Example 4: Synthesis of Polyurethane Adhesive

To 100 g of the polyurethane solution in MEK from Example 3, 0.45 g Tetrad X, a highly-reactive, tetra-functional, amine-based epoxy resin, was added and stirred to form a homogenous solution, which was then coated on a release liner and dried at 70° C. for 20 h to obtain crosslinked polyurethane adhesive article.

### Example 5: Synthesis of Polyurethane Solution

To a resin reaction vessel equipped with mechanical stirrer, a condenser and a nitrogen inlet were added 200.0 g polyester polyol obtained from Example 1, 5.47 g Ymer N120, 50.0 g of MEK, 0.11 g of DBTDA, 0.11 g of BHT, 1.1 g of BAGA, and 12.25 g Desmodur H. The reaction was carried at 80° C. with stirring until no free NCO group was observed by FT-IR. During the reaction, a certain amount of MEK was added to adjust the viscosity, resulting in clear and transparent polyurethane solution in MEK with 40% solid. The GPC data were as follows: Mn=34.9 kDaltons, Mw=124.4 kDaltons and Pd=3.55.

### Example 6: Synthesis of Polyurethane Adhesive

To 74 g of the polyurethane solution from Example 5, 2.66 g CN 983 (50% solid in MEK), 0.072 g KbM-403 (10% in MEK), 0.36 g TPO (10% in MEK), 1.03 g Tetrad X (10% solid) were added and stirred to form a homogeneous solution, which was then coated on a release liner (such as RF02N) and dried at 70° C. for 20 min to form about a 2 mil thick polyurethane adhesive. A top liner (such as a J9 liner silicone coated polyester release liner available from Nippa Corp., Osaka, Japan) was laminated to the faceside of the adhesive to form an adhesive transfer tape of the polyurethane adhesive disposed between the two liners. The transfer tape was then UV-cured using a Fusion UV system (Heraeus Inc., Yardley, Pa.) with a dosage of 3 J/cm² using a D-bulb to form a cross-linked polyurethane pressure sensitive adhesive.

### Comparative Example 1: Synthesis of Polyurethane Adhesive

To a resin reaction vessel equipped with mechanical stirrer, a condenser and a nitrogen inlet were added 302.12 g hydroxyl terminated polyester PH-56 with a hydroxyl number of 57.3 mg KOH/g, 50 g of MEK, 0.17 g of DBTDA, 1.65 g of DMPA, and 28.01 g Desmodur H. The reaction was carried at 80° C. with stirring until no free NCO group was observed by FT-IR. During the reaction, a certain amount of MEK was added to adjust the viscosity, resulting in clear and transparent polyurethane PSA solution in MEK with 45% solid. The GPC data were as follows: Mn=47.8 kDaltons, Mw=105.7 kDaltons and Pd=2.77.

The chemical resistance, peel strength on stainless steel, the glass transition temperature (Tg) as measured by DSC and the G′ for Examples 3-6 and Comparative Example 1 are shown in Tables 2 and 3 below.

TABLE 2

| | Resistance Rating | | Peel on SS/24 hrs | Failure |
|---|---|---|---|---|
| Example | Oleic Acid | IPA/H₂O | RT dwell (N/mm) | mode |
| Example 3 | 5 | 4 | 1.72 | adhesive |
| Example 4 | 5 | 5 | 1.58 | adhesive |
| Example 5 | 5 | 4 | 1.64 | cohesive |
| Example 6 | 5 | 5 | 1.50 | adhesive |
| Comparative | 5 | 4 | 1.45 | adhesive |
| Example 1 | | | | |

TABLE 3

| Example | Mw (kilo Daltons) | Tg | G′ at 25° C. |
|---|---|---|---|
| Example 3 | 132 | −26.2 | N/A |
| Example 4 | NA | −25.2 | N/A |
| Example 5 | 124 | −28.0 | 1.56 × 10⁵ Pa |
| Example 6 | NA | −27.5 | 1.65 × 10⁵ Pa |
| Comparative | 107 | −0.5 | 5.7 × 10⁵ Pa |
| Example 1 | | | |

N/A means not measured or not available

As shown above, Examples 3-6 and Comparative Example 1 have similar resistance to oleic acid and IPA/water and similar peel adhesion to stainless steel. However, Comparative Example 1 has a modulus higher than Examples 3-6 and is not tacky due to the G′ being higher than 300 kPa at 25° C.

### Example 7: Synthesis of Polyurethane Optically Clear Adhesive (OCA)

To 109.28 g of the polyurethane solution prepared the same manner as Example 5 (47.1 wt %), 5.15 g CN 983 (50 wt % solid in MEK), 0.028 g KbM-403 (10% in MEK), 1.5 g TPO (10% in MEK), 0.4 g Tetrad X (10 wt % in MEK) and 1.08 g XR5580 (50 wt % in methoxypropyl acetate) were added in a brown jar and stirred on a roll mixer to form a homogeneous solution. The solution was coated on RF02N liner using a knife coater to control the thickness, then the coated RF02N liner was placed in a 70° C. solvent drying oven for 30 min to remove the solvent. Finally, a J9 liner (silicone coated polyester release liner available from Nippa Corp., Osaka, Japan) was laminated on the dried adhesive surface to form a laminated article comprising RF02N liner/a 4 mil (about 102 micron) thick polyurethane adhesive/J9 liner. The adhesive tape was placed in a black bag to prevent it from inadvertently crosslinking upon exposure to light.

Performance Evaluation of Example 7:

Haze and b*: A Hunterlab UltraScan Pro Spectrophotometer (Hunter Associates Laboratory Inc., Reston, Va.) was used to determine the CIELAB color space and % haze of a liquid crystal display (LCD) glass by itself and the polyurethane adhesive laminated to the LCD glass. The easy liner (RF02N) was peeled off the laminated article from Example 7, and the polyurethane adhesive was roller-laminated onto liquid crystal display (LCD) glass, and the tight (Nippa J9) liner was removed to generate a polyurethane adhesive laminated to the LCD glass (available under the trade designations “EAGLE XG SLIM GLASS”, Corning Inc., NY). The results are shown in Table 4 below.

TABLE 4

| | L* | a* | b* | Haze % |
|---|---|---|---|---|
| Control: LCD Glass | 96.82 | −0.01 | 0.14 | 0.05 |
| Adhesive from Example | 96.72 | −0.14 | 0.53 | 0.15 |
| 7 on LCD Glass | | | | |

Chemical Resistance: The adhesive tape from Example 7 was conditioned for at least 2 hours at ambient conditions and then UV-cured at 3 J/cm². The cured sample was then tested for chemical resistance. The sample had a chemical resistance rating of 5 to both to oleic acid and IPA/water (70/30).

Peel Adhesion: The 180-degree peel adhesion test for the polyurethane adhesive on float glass aged at various temperatures was determined. The easy liner (RF02N) was peeled off the laminated article from Example 7 and a 2 mil (50 micron) PET film was laminated on the top surface of the adhesive; the resulting PET/adhesive/tight liner film was cut to 1-centimeter wide strips. Then, the tight liner was peeled off, and the adhesive strips were roller-laminated with three passes (wherein one pass is a forward and backward roll) of a 5 pound roller onto a float glass plate 2 in×5 in. The float glass plate (soda lime window glass from Swift Glass Co. Inc., Elmira Heights, N.Y.) was cleaned prior to applying the tape by cleaning the test surface of the glass with 2 or 3 isopropanol washes and wiping with a tissue paper (such as that available under the trade designation KIMWIPE). After being conditioned for 2 hours at 25° C. and 40% relative humidity, the samples (PET/adhesive/glass) were UV-cured using a Fusion UV system with a dosage of 3 J/cm² using a D-bulb, operated under N₂. After curing, the samples allowed to stand for at least 24 hours at at 25° C. and 40% relative humidity, then the samples were heated to various temperatures and then peeled at 60 mm/cm using a peel tester (available under the trade designation “MTS CRITERION MODEL 45” available from MTS Systems Corp., Eden Prairie, Minn.) equipped with an oven (Lab-Temp, available from Thermcraft Inc., Winston-Salem, N.C.). The results are shown below. Typically, 5 peel adhesion tests were done per sample.

TABLE 5

| | Average Peel | |
|---|---|---|
| Temperature | Strength (N/cm) | Failure Mode |
| 25° C. | 16.5 | Adhesive |
| 65° C. | 7.3 | Adhesive |
| 85° C. | 3.2 | Adhesive |

Modulus, tan delta and Tg: The modulus, tan delta, and Tg for the uncured and cured adhesive tape (cured at 3 J/cm²) was tested by Dynamic Mechanical Thermal Analysis (DMA). Using an ARES G2 rheometer (available from TA instruments, New Castle, Del.), DMA testing was carried out on the polyurethane adhesive using a parallel plate geometry with 8 mm diameter plates and a gap of 1.5 mm. Testing was conducted using a temperature scan rate of 3° C./min at a frequency of 1 Hertz and a maximum strain of 20%. The scans were formed from −20° C. to 100° C. The data are summarized below.

TABLE 6

| Polyurethane adhesive | | |
|---|---|---|
| | Not cured | Cured |

| | | | | |
|---|---|---|---|---|
| G′ at 25° C. | 1.80 × 10⁵ | Pa | 2.28 × 10⁵ | Pa |
| G′ at 60° C. | 4.14 × 10⁴ | Pa | 7.40 × 10⁴ | Pa |
| G′ at 70° C. | 2.69 × 10⁴ | Pa | 5.38 × 10⁴ | Pa |
| G′ at 85° C. | 1.32 × 10⁴ | Pa | 3.66 × 10⁴ | Pa |

| | | |
|---|---|---|
| Tan delta at 25° C. | 0.46 | 0.40 |
| Tan delta at 60° C. | 0.96 | 0.64 |
| Tan delta at 70° C. | 1.10 | 0.67 |
| Tan delta at 85° C. | 1.32 | 0.69 |

| | | | | |
|---|---|---|---|---|
| Tg | −16.67° | C. | −14.84° | C. |

The ability of the adhesive to conform to a three-dimensional surface was evaluated as follows: A 5 inch (127 mm)×7 inch (178 mm) LCD glass substrate was printed with 16 “cross shaped” black inks ranging from 20 micron to 40 micron in height. The cross shaped black inks were 1.8-centimeter-long and 0.5-centimeter-wide. The laminated article from Example 7 was cut to about the same size as the 5 inch×7 inch glass substrate, while the easy liner was replaced by 2 mil (50 micron) PET film. The uncured adhesive sample were laminated onto the printed side of the glass substrate using a roller. Then the laminated article was subjected to an autoclave treatment using an autoclave (model number J-15501 available from Lorimer Corporation, Longview, Tex.) at a temperature of 50° C., and 0.5 MPa pressure for 30 min. Five laminations were tested, in each, the polyurethane adhesive was able to conform to the ink steps up to 40 microns in height without trapping any bubbles during lamination. The laminated samples were further UV-cured under 3 J/cm² D-bulbs, and were subjected to durability tests (65° C./90% relative humidity for 6 hours), and no new bubbles developed.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail

1. A polyester polyol comprising:
a first reaction product of
(a) a Component A, wherein the Component A is a phthalic acid, a phthalic anhydride or mixtures thereof,
(b) a Component B, wherein the Component B is a dimer fatty acid, a dimer fatty acid diol or mixtures thereof, and
(c) a Component C, wherein the Component C is an aliphatic diol, an aromatic diol, or mixtures thereof, wherein Component C comprises 2 to 10 carbon atoms and optionally at least one catenated heteroatom, wherein the heteroatom is selected from O, S, and N.

2. The polyester polyol of claim 1, wherein the average number of carbons in the dimer fatty acid or the dimer fatty acid diol is at least 20 and no more than 45.

3. The polyester polyol of claim 1 derived from 20 to 60 wt % of the Component A, 10 to 60 wt % of the Component B, and 20 to 60 wt % of the Component C.

4. The polyester polyol of claim 1, wherein the Component C comprises at least one of 1,4-butanediol, 1,6-hexanediol, and 1,8-octanediol.

5. The polyester polyol of claim 1, wherein the first reaction product further comprises no more than 25 wt % of a second aliphatic or aromatic diol, wherein the second aliphatic or aromatic diol is selected from ethylene glycol, an aliphatic diol comprising more than 10 carbon atoms or aromatic diol comprising more than 10 carbon atoms.

6. The polyester polyol of claim 1, wherein the first reaction product further comprises no more than 25 wt % of a second diacid.

7. The polyester polyol of claim 1; having a Tg below 15° C.

8. A polyurethane polymer comprising a second reaction product of (a) the polyol according to claim 1, and (b) a polyisocyanate component.

9. The polyurethane polymer of claim 8, wherein the polyisocyanate component comprises an aliphatic polyisocyanate, an aromatic polyisocyanate, or a mixture thereof.

10. The polyurethane polymer of claim 8, wherein the second reaction product is derived from 55-99 wt % of the polyester polyol.

11. The polyurethane polymer of claim 8, wherein the second reaction product is derived from 1 to 35 wt % of the polyisocyanate component.

12. The polyurethane polymer of claim 8, wherein the second reaction product further comprises a functional acid.

13. A pressure sensitive adhesive comprising the polyester polyol of claim 1, having a number average molecular weight of greater than 10,000 g/mol and at most 100,000 g/mol.

14. A pressure sensitive adhesive comprising the polyurethane polymer of claim 8.

15. The pressure sensitive adhesive composition of claim 14, wherein the pressure sensitive adhesive composition further comprises 0.1 to 5% by weight of a light sensitive derivative.

16. The pressure sensitive adhesive composition of claim 14, wherein the pressure sensitive adhesive retains a tan delta value of between about 0.4 and about 1.5 over a temperature range of between about 25° C. and about 85° C. and a frequency of 1 Hz.

17. A laminating tape comprising
a substrate; and
a layer of a pressure sensitive adhesive composition according to claim 14 disposed on a major surface of the substrate.

18. A method of bonding comprising
providing a first substrate,
contacting a surface of the first substrate with the pressure sensitive adhesive composition of claim 14.

19. The polyester polyol of claim 1, having a number average molecular weight of at least 1000 g/mole and not more than 10,000 g/mol.

20. The polyester polyol of claim 1, having a number average molecular weight of greater than 10,000 g/mol and at most 100,000 g/mol.
